(19) United States
(12) Patent Application Publication
(10) Pub. No.: US 2005/0204524 A1
(43) Pub. Date: Sep. 22, 2005

(54) Memorial carrier

(76) Inventor: Wayne B. Morris, Toms River, NJ (US)

Correspondence Address: WAYNE B. MORRIS, 11 CHIPPEWA ROAD, TOMS RIVER, NJ, 08753, US

(21) Appl. No.: 10/802,832

(22) Filed: Mar. 18, 2004

(51) Int. Cl. H01R 11/20

(52) U.S. Cl. 27/10

(57) ABSTRACT

The Memorial Carrier is unique and never been seen on the market. It's design was created out of a need for a loved ones Memorial. The Memorial carrier allows you to have a floral arrangement created around the Urn, Photo, and or Remembrance item making a beautiful surround for everyone to remember. The structure of the carrier enables the ease of transporting to the service, ceremony, and or final resting place.

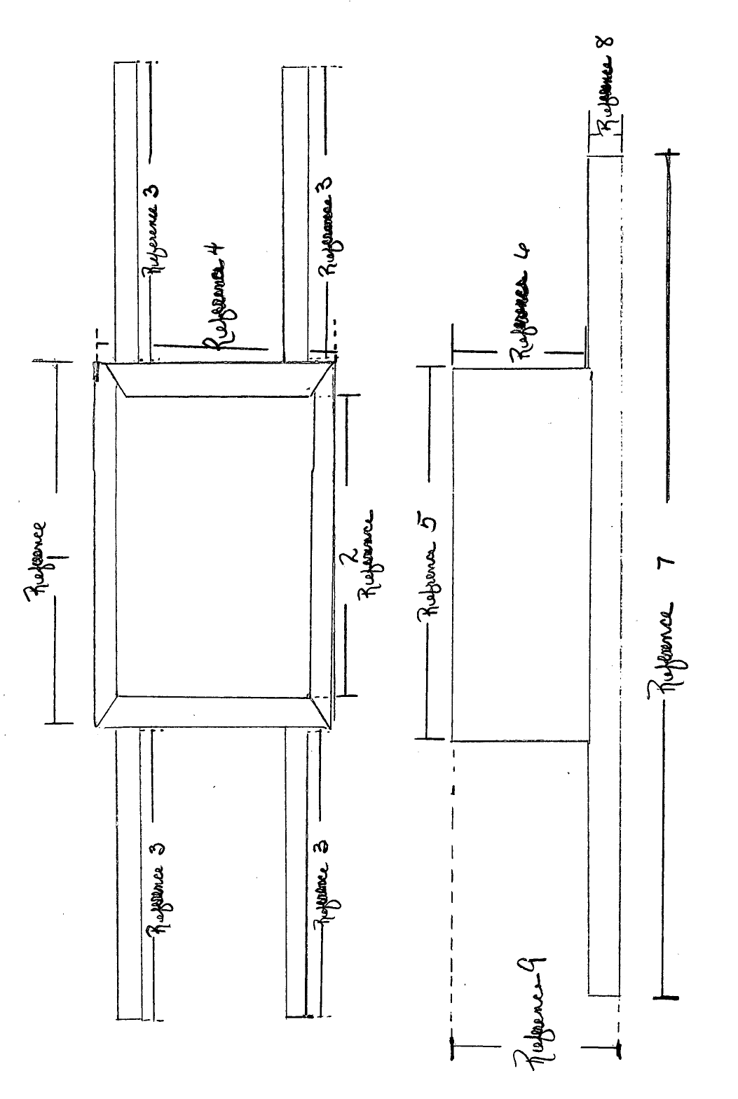

The Memorial Carrier is made of pine but can be made of other woods if preferred by client. The polls are made of 1″×2″, the bottom of the carrier base is 1″×12″, and the side frames are 1″×4″. The side panels are cut on 45-degree angles measuring 11 ¼″ therefore making the outside 12 ½″ and are mitered together forming the box, which is screwed into the bottom base, which measures 11 ¼″. After the box is completed it is then centered and screwed onto the two 31″ polls.

The Memorial Carrier will have different decorative options that will be added to the initial Carrier base. The options include candleholders so as the Carrier box can have a candle on each corner, all different scrollwork which will be glued and or screwed to Carrier sides of base, and decorative molding screwed onto the Carriers base, and polls. The Memorial Carrier can be painted and or stained.

The Memorial Carrier will be marketed to Funeral Directors, Funeral Homes, Memorial Homes, Crematories, Florists, and businesses of the like.

| REFERENCE | DESCRIPTION | MEASUREMENT | |
|---|---|---|---|
| 1 | OUTSIDE FRAME OF BASE | 12½ | inches |
| 2 | BASE OF CARRIER | 11¼ | inches |
| 3 | SIZE OF POLLS FROM BASE | 9 | inches |
| 4 | OUTSIDE FRAME OF BASE | 12½ | inches |
| 5 | SIZE OF BOX | 12½ | inches |
| 6 | HEIGHT OF BOX | 3½ | inches |
| 7 | TOTAL LENGTH OF CARRIER | 31 | inches |
| 8 | HEIGHT OF POLL | 1½ | inches |
| 9 | TOTAL HEIGHT OF CARRIER | 5 | inches |

I. What I claim as my invention is The Memorial Carrier to be used for but not restricted to:
carry Urns, photos, or remembrance items of loved ones arranged centered within a floral arrangement
allow the use of pall bears to carry the Memorial Carrier into the services, ceremonies and to the final resting place
display as a keepsake at the final resting place

II. The Memorial Carrier of claim 1 is constructed with Pine wood and the items mentioned in claim 1 will be housed in the Carrier which:
is 12½ inches squared and will be screwed into two 31 inch polls will have 9 inches to extend out of the sides of the Carrier structure for carrying allows easy transport of loved ones remains and or memorabilia to and from services, ceremonies, and final resting place
can be plain, painted, stained, decoratively trimmed, molded and/or customized to client's specifications.
